(19) United States
(12) Patent Application Publication
(10) Pub. No.: US 2001/0008996 A1
(43) Pub. Date: Jul. 19, 2001

(54) MP3 CD output system for a vehicle

(76) Inventor: Ki Bok Choi, Incheon (KR)

Correspondence Address: Harness, Dickey & Pierce, P.L.C., P. O. Box 828, Bloomfield Hills, MI, 48303, US

(21) Appl. No.: 09/756,957

(22) Filed: Jan. 9, 2001

(30) Foreign Application Priority Data
Jan. 14, 2000 (KR) P 2000-1643

(51) Int. Cl. G10L 19/00; G10L 21/00

(52) U.S. Cl. 704/500

(57) ABSTRACT

The present invention relates to an MP3 CD output system for vehicles, capable of reproducing MP3 audio files regardless of the joggling of a vehicle by using an audio compact disc(CD) deck equipped in the vehicle.

In a system for outputting an audio signal through a stereo unit in a vehicle having the stereo unit equipped with a deck for reproducing a compact disc(CD), a recording medium for recording audio data compressed according to an audio compression mode; and a compression audio reproducing unit for performing communications with the stereo unit, inputting and restoring the compressed audio data reproduced through the deck, delaying the restored audio signal for a predetermined time, and converting the restored audio signal into an analog audio signal in a delayed order for an output are comprised. The compression audio reproducing unit processes an audio signal delayed for about 10 seconds to be finally outputted through speakers of the vehicle, so that a driver and others can listen to a song outputted from the speaker without interruption even in case that an optical pickup device is deviated from a track due to the moving of the deck itself with the vehicle severely joggling by external factors or due to the vibrations of the deck.

### BACKGROUND OF THE INVENTION

1. Field of the Invention

The present invention relates to an MP3(MPEG-1 Audio Layer 3) CD output system for a vehicle, and more particularly to an MP3 CD output system for vehicles, capable of reproducing MP3 audio files regardless of the joggling of a vehicle by using an audio compact disc(CD) deck equipped in the vehicle.

2. Reference to Related Patents Applications

U.S. Pat. No. 5,677,960 On-vehicle sound control apparatus

U.S. Pat. No. 5,742,893 Music-playing system for a motor vehicle

U.S. Pat. No. 5,784,473 Sound system

U.S. Pat. No. 6,025,654 Method for controlling the transmission of data between components and component for implementing the method

U.S. Pat. No. 6,114,774 Entertainment system for motor vehicles

3. Description of Related Arts

In general, an audio output system called a car stereo system is equipped in a vehicle, which is a system for supporting the AM radio receptions, FM radio receptions, cassette tape reproductions, or CD reproductions, enabling occupants in the vehicle to listen to audio outputs according to driver's manipulations.

In recent, the car stereo system for a vehicle is being replaced with a system having a CD deck as its constituent instead of the cassette tape deck for reproducing cassette tapes. This is because, in case of cassette tapes generally being magnetic tapes, the cassette tapes elongate as a driver repeatedly reproduces the cassette tapes for a long time so that the driver's normal listening to music is disturbed.

Therefore, the cassette tape deck is being replaced with a CD deck of having advantages that music can be provided in a more clear and vivid sound quality as well as that the recording medium is not damaged even though it is repeatedly reproduced for a long time.

However, since more than 14 songs can not be recorded in one audio CD even in case of the CD deck as stated above, there exists a problem in that a driver carries plural CDs with him or installs a CD changer of a high-price equipment in a certain place of a vehicle such as a vehicle trunk in order for him to listen to as many songs through the car stereo system.

### SUMMARY OF THE INVENTION

The present invention is devised to solve the above problem, so it is an object of the present invention to provide an MP3 CD output system capable of outputting a normal audio signal through speakers by using a temporary store memory for reproduced MP3 audio data even in a case that an optical pickup device in the audio CD deck of a car stereo system is deviated from a track being reproduced due to external environment factors.

In order to achieve the above object, the system according to the present invention, in an audio output system for a vehicle having a stereo unit equipped with a deck for reproducing a compact disc(CD), comprises a recording medium for recording audio data compressed according to an MP3(MPEG-1 audio layer 3) audio compression mode; and an MP3 audio reproducing unit for performing communications with the stereo unit, inputting and restoring the compressed audio data reproduced through the deck, delaying the restored audio signal for a predetermined time, and converting the restored audio signal into an analog audio signal in a delayed order for an output.

Further, another system according to the present invention, in an audio output system for a vehicle having a stereo unit equipped with a deck for reproducing a compact disc(CD), comprises an amplification unit for receiving from the deck and amplifying a pickup signal outputted from the CD on which MP3 data is recorded; a digital signal processing unit for extracting a signal recorded on the CD by frame unit based on the pickup signal transferred from the amplification unit; a first decoding processing unit for receiving the CD signal extracted by frame unit by the digital signal processing unit and performing data error corrections; a temporary storage unit for receiving the error-corrected CD signal from the first decoding processing unit and storing the received CD signal for a predetermined time; a second decoding processing unit for sequentially receiving the delayed CD signal from the temporary storage unit and decoding the received delayed CD signal into audio data; a conversion unit for converting into an analog audio signal the audio data decoded in the second decoding processing unit for an output; a motor driving unit for outputting a driving signal for controlling a motor operating for the deck to extract the pickup signal from the CD; and a control unit for receiving and transferring data from and to the stereo unit and other respective components and controlling an entire system.

### BRIEF DESCRIPTION OF THE DRAWINGS

The above object and other advantages of the present invention will become more apparent by describing in detail a preferred embodiment thereof with reference to the attached drawings, in which:

FIG. 1 is a schematic block diagram for explaining a structure of an MP3 CD output system for a vehicle according to an embodiment of the present invention; and

FIG. 2 is a block diagram for explaining a detailed structure of an MP3 audio reproducing unit of FIG. 1.

### DETAILED DESCRIPTION OF THE PREFERRED EMBODIMENT

Hereinafter, operations of an MP3 CD output system for a vehicle according to an embodiment of the present invention will be described in detail with reference to the accompanying drawings.

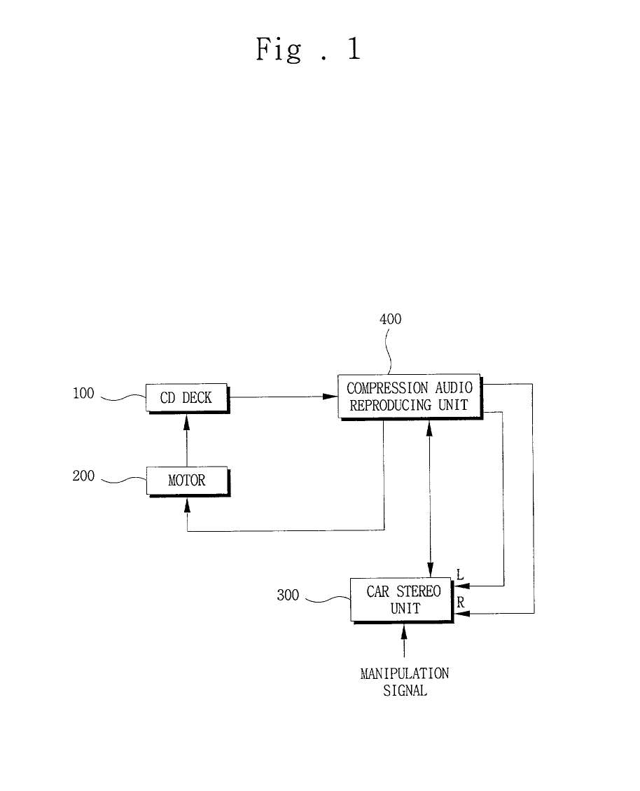

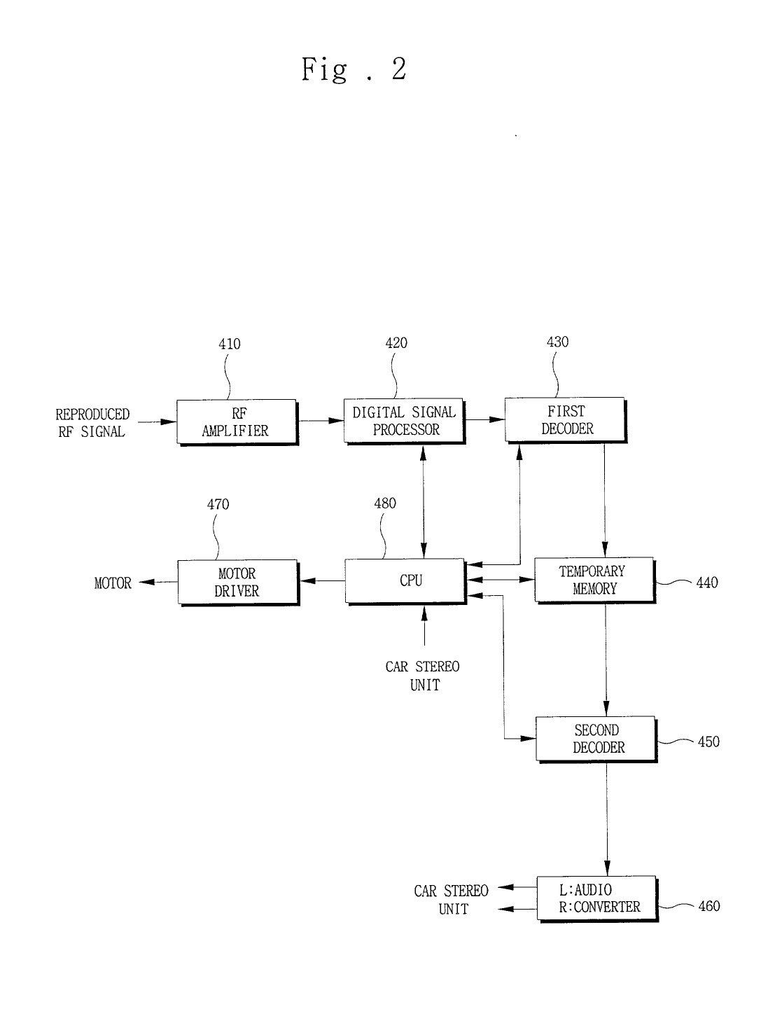

FIG. 1 is a schematic block diagram for explaining a structure of an MP3 CD output system for a vehicle according to an embodiment of the present invention, and FIG. 2 is a block diagram for explaining a detailed structure of an MP3 audio reproducing unit of FIG. 1.

As shown in FIG. 1 and FIG. 2, the MP3 CD output system for a vehicle includes a CD deck 100, a motor 200 for driving a CD to reproduce an audio signal recorded on the CD, a store medium for storing audio data compressed according to an MP3 audio compression mode, and an MP3 audio reproducing unit(or compression audio reproducing unit) 400 for receiving and restoring the compressed audio data reproduced through the CD deck 100 while performing communications with a car stereo unit 300, delaying the restored audio signal for a certain time, and converting the restored audio signal into an analog audio signal in a delayed order for an output.

The MP3 audio reproducing unit 400 has an RF amplifier 410 for amplifying an RF signal reproduced by a pickup device of the CD deck 100, a digital signal processor 420 for signal-processing the amplified RF signal of the RF amplifier 410 by frame unit in response to a control signal inputted from a CPU 480 and extracting only compressed audio signal according to a predetermined mode, a first decoder 430 for correcting errors of the compressed audio data extracted from the digital signal processor 420 in response to a control signal inputted from the CPU 480, a temporary memory 440 for storing the error-corrected audio data of the first decoder 430 for a predetermined time in response to a control signal inputted from the CPU 480, a second decoder 450 for reading the error-corrected audio data from the temporary memory 440 in response to a control signal inputted from the CPU 430 and restoring the compression of the data, an audio converter 460 for converting the audio signal restored in the second decoder 450 into an analog audio signal and outputting the analog audio signal to external speakers through the stereo unit, a motor driver 470 for driving the motor in response to a driving control signal inputted from the CPU 480, and the CPU 480 for performing communications with the stereo unit 300 and controlling the entire system.

The car stereo unit 300 and the CPU 480 mutually exchange information according to a serial control mode. The IIC communication mode, which is one of the serial control modes, is employed.

In the meantime, the temporary memory 440 stores a quantity of 10-second audio data, the second decoder 450 reads and restores the audio data stored in the temporary memory 440 by predetermined frame in a stored order so that songs are normally outputted through the speakers without interruptions in case that the optical pickup device of the CD deck 100 is deviated from CD tracks being reproduced due to the conditions of a road on which the vehicle runs.

Next, operations of the audio output system for a vehicle, which has a structure as stated above, according to the present invention will be described with reference to FIG. 1 and FIG. 2.

First of all, the CPU 480 of the MP3 audio reproducing unit (compression audio reproducing unit) 400 receives and transfers signals from and to the car stereo unit 300 according to the IIC communication mode, to thereby recognize the intention of a driver.

That is, in case that the driver mounts a CD on which MP3 audio data is recorded or selects one of the songs recorded on the CD after the mounting, the car stereo unit 300 recognizes the mounting or the selection and outputs a predetermined signal to the CPU 480. According to this, the CPU 480 controls the entire system.

First of all, the CPU 480 outputs a motor driving signal to the motor 200 through a motor driver 470 in order to rotate the CD mounted in the CD deck 100.

Accordingly, data recorded on the CD is retrieved to a radio frequency(RF) signal through the optical pickup device, and the retrieved RF signal is outputted to the RF amplifier 410.

The RF amplifier 410 amplifies the RF signal retrieved by the optical pickup device by a level enough to be processed. The amplified signal is inputted to the digital signal processor 420, and gone through varied processes such as releasing interleave and scramble processes for signal-processing, so that the signal is converted to a pure MP3 audio digital signal prior to the recording on a CD and then-outputted frame by frame according to the control of the CPU 480.

At this time, the first decoder 430 inputs the MP3 audio digital signal frame by frame according to the control of the CPU 480, checks errors, and outputs the error-corrected MP3 audio digital signal.

The MP3 audio digital signal is stored in the temporary memory 440 according to the control of the CPU(480). The temporary memory 440 stores at one time the MP3 audio digital signal to be outputted for 10 seconds, and outputs the stored MP3 audio digital signal on a first-input first-output basis according to the control of the CPU 480.

Since as much quantity of the MP3 audio digital signal as outputted for 10 seconds is stored in the temporary memory 440, a driver can listen to songs which are not interrupted through the speakers even in case that the optical pickup device in a car stereo system is deviated from a track position being reproduced as the car stereo system which is reproducing an MP3 audio CD at present joggles due to the running of a vehicle or the like.

The MP3 audio signal outputted from the temporary memory 440 is inputted to the second decoder 450, and the second decoder 450 restores the MP3 audio signal and then converts the restored MP3 audio signal into a general digital audio signal.

The audio signal restored by the second decoder 450 goes through the audio converter 460 to be converted into an analog signal outputted through left and right speakers of the vehicle, and the analog signal is inputted to the left(L) and right(R) terminals of the car stereo unit 300, so that a song chosen by a driver or the others can be heard.

Designers of an existing car stereo unit can easily modify parts of a communication program for the CPU of the car stereo unit in order for the MP3 audio reproducing unit 400 to be applied for the present invention, and realize that the CPU 480 of the MP3 audio reproducing unit 400 controls the CD deck 100 through serial communications using only three IC pins.

The MP3 CD audio output system according to the present invention, as stated above, has an effect that a driver can listen to varied songs without the preparation of plural CDs or a high-price CD changer since, in case that song data compressed by MP3 audio compression technologies is recorded on a CD, about 140 songs can be recorded on one CD.

Further, the present invention can store as much quantity of a reproduced MP3 audio signal as 10 seconds by using a temporary memory.

Furthermore, the present invention has another effect that a driver or others can listen to a song without any interruption of the song even in case that an optical pickup device in a CD deck is deviated from a track being reproduced with a vehicle severely joggling due to external factors by outputting a reproduced signal through speakers after delaying the reproduced signal by about 10 seconds with use of the temporary memory.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. In an audio output system for a vehicle having a stereo unit equipped with a deck for reproducing a compact disc(CD), an MP3 CD output system for the vehicle comprising:
a recording medium for recording audio data compressed according to an MP3(MPEG-1 audio layer 3) audio compression mode; and
an MP3 audio reproducing unit for performing communications with the stereo unit, inputting and restoring the compressed audio data reproduced through the deck, delaying the restored audio signal for a predetermined time, and converting the restored audio signal into an analog audio signal in a delayed order for an output.

2. The MP3 CD output system as claimed in claim 1, wherein the MP3 audio reproducing system includes:
an RF amplifier for amplifying an radio frequency(RF) signal reproduced by a pickup device of the deck;
a digital signal processor for signal-processing the RF signal amplified in the RF amplifier by frame unit and extracting only MP3 audio data according to a predetermined mode, in response to a control signal inputted from external;
a first decoder for correcting errors of the audio data extracted from the digital signal processor in response to the control signal inputted from the external;
a temporary memory for storing the audio data error-corrected in the first decoder for a predetermined time in response to the control signal inputted from the external;
a second decoder for reading and restoring the error-corrected audio data from the temporary memory in response to the control signal inputted from the external;
an audio converter for converting the audio signal restored in the second decoder into an analog audio signal and outputting the analog audio signal to external speakers through the stereo unit;
a motor driver for driving a motor in response to a driving control signal inputted from the external; and
a central process unit(CPU) for controlling an entire system while performing intercommunications with the stereo unit.

3. The MP3 CD output system as claimed in claim 1, wherein the stereo unit and the CPU exchange information therebetween according to a serial control mode.

4. The MP3 CD output system as claimed in claim 3, wherein the serial control mode is an IIC communication mode.

5. The MP3 CD output system as claimed in claim 2, wherein the stereo unit and the CPU exchange information therebetween according to a serial control mode.

6. The MP3 CD output system as claimed in claim 5, wherein the serial control mode is an IIC communication mode.

7. The MP3 CD output system as claimed in claim 2, wherein the temporary memory stores as much audio data as several seconds, and outputs the stored audio data on a first-input first-output basis according to the control of the CPU.

8. The MP3 CD output system as claimed in claim 7, wherein the stereo unit and the CPU exchange information therebetween according to a serial control mode.

9. The MP3 CD output system as claimed in claim 8, wherein the serial control mode is an IIC communication mode.

10. In an audio output system for a vehicle having a stereo unit equipped with a deck for reproducing a compact disc(CD), an MP3 CD output system for the vehicle comprising:
means for receiving from the deck and amplifying a pickup signal outputted from the CD on which MP3 data is recorded;
digital signal processing means for extracting a signal recorded on the CD by frame unit based on the pickup signal transferred from the amplifying means;
first decoding processing means for receiving the CD signal extracted by frame unit by the digital signal processing means and performing data error corrections;
temporary storage means for receiving the error-corrected CD signal from the first decoding processing means and storing the received CD signal for a predetermined time;
second decoding processing means for sequentially receiving the delayed CD signal from the temporary storage means and decoding the received delayed CD signal into audio data;
means for converting into an analog audio signal the audio data decoded in the second decoding processing means for an output;
means for outputting a driving signal for controlling a motor operating for the deck to extract the pickup signal from the CD; and
means for receiving and transferring data from and to the stereo unit and other respective components and controlling an entire system.

11. The MP3 CD output system as claimed in claim 10, wherein the temporary storage means stores a received CD signal, delays the CD signal for a predetermined time, and sequentially outputs the delayed CD signal based on a received order according to the control of the control means.
